(19) United States
(12) Patent Application Publication
(10) Pub. No.: US 2025/0118872 A1
(43) Pub. Date: Apr. 10, 2025

(54) BATTERY UNIT AND WIRING UNIT FOR BATTERY

(71) Applicant: MURATA MANUFACTURING CO., LTD., Kyoto (JP)

(72) Inventors: Masashi SATO, Kyoto (JP); Hiroyuki ITO, Kyoto (JP)

(21) Appl. No.: 18/984,510

(22) Filed: Dec. 17, 2024

Related U.S. Application Data
(63) Continuation of application No. PCT/JP2023/040177, filed on Nov. 8, 2023.

(30) Foreign Application Priority Data
Nov. 10, 2022 (JP) 2022-180494

(51) Int. Cl. H01M 50/528; H01M 50/548

(52) U.S. Cl. CPC H01M 50/528; H01M 50/548

(57) ABSTRACT

A battery unit is provided and includes a battery and a wiring unit. The battery includes an outer package can that includes a first surface on which a first electrode terminal is exposed, a second surface on which a second electrode terminal is exposed, and a side surface coupling the first surface and the second surface to each other. The second surface is disposed on a side opposite to the first surface. The wiring unit includes a first coupling terminal to be welded to the first electrode terminal, a second coupling terminal to be welded to the second electrode terminal, and a flexible wiring substrate. The flexible wiring substrate includes a first support part, a second support part, a middle part, a first wire, and a second wire. The first support part supports the first coupling terminal. The second support part supports the second coupling terminal. The middle part couples the first support part and the second support part to each other. The first wire extends from the first coupling terminal, through the first support part, to the middle part. The second wire extends from the second coupling terminal, through the second support part, to the middle part.

### CROSS REFERENCE TO RELATED APPLICATIONS

The present application is a continuation of International patent application no. PCT/JP2023/040177, filed on Nov. 8, 2023, which claims priority to Japanese patent application no. 2022-180494, filed Nov. 10, 2022, the entire contents of which are incorporated herein by reference.

### BACKGROUND

The present disclosure relates to a battery unit, and to a wiring unit for a battery to be used in the battery unit.

A battery unit has been known that includes a battery and a flexible wiring substrate. The battery includes a positive electrode terminal and a negative electrode terminal. The flexible wiring substrate includes wiring coupled to the battery. A configuration of such a battery unit has been considered in various ways.

A battery unit is disclosed that includes, for example, a battery, a flexible substrate, and a fixing member. The battery includes a positive electrode terminal and a negative electrode terminal. The flexible substrate includes multiple contact terminals each of which is in contact with the corresponding one of the positive electrode terminal and the negative electrode terminal. The fixing member fixes the flexible substrate on the battery. The flexible substrate is disposed to be laid over all or a part of the battery and is fixed by the fixing member without being joined to the battery.

### SUMMARY

The present disclosure relates to a battery unit, and to a wiring unit for a battery to be used in the battery unit.

Consideration has been given in various ways to improve performance of a battery unit. However, there is room for improvement in terms of the performance of the battery unit.

It is therefore desirable to provide a battery unit that is easy to handle and has high reliability.

The battery unit according to an embodiment of the present disclosure includes a battery and a wiring unit. The battery includes an outer package can that includes a first surface on which a first electrode terminal is exposed, a second surface on which a second electrode terminal is exposed, and a side surface coupling the first surface and the second surface to each other. The second surface is on a side opposite to the first surface. The wiring unit includes a first coupling terminal to be welded to the first electrode terminal, a second coupling terminal to be welded to the second electrode terminal, and a flexible wiring substrate. The flexible wiring substrate includes a first support part, a second support part, a middle part, a first wire, and a second wire. The first support part supports the first coupling terminal. The second support part supports the second coupling terminal. The middle part couples the first support part and the second support part to each other. The first wire extends from the first coupling terminal, through the first support part, to the middle part. The second wire extends from the second coupling terminal, through the second support part, to the middle part.

According to a battery unit of an embodiment of the present disclosure, high ease of handling and high reliability are achievable.

Note that effects of the present disclosure are not necessarily limited to those described above and may include any of a series of effects described below in relation to the present disclosure.

### BRIEF DESCRIPTION OF FIGURES

FIG. 1A is a perspective diagram illustrating a configuration example of a battery unit according to an embodiment of the present disclosure.

FIG. 1B is a perspective diagram illustrating a configuration example of an external appearance of a secondary battery illustrated in FIG. 1A.

FIG. 2A is a perspective diagram illustrating a configuration example of a wiring unit illustrated in FIG. 1A in an unbent state.

FIG. 2B is an exploded perspective diagram illustrating a configuration example of the wiring unit illustrated in FIG. 1A in the unbent state.

FIG. 3 is a sectional diagram illustrating a configuration example of the battery unit illustrated in FIG. 1A.

FIG. 4 is a sectional diagram illustrating a detailed configuration example of the secondary battery illustrated in FIG. 1A.

FIG. 5 is a sectional diagram illustrating a configuration example of a battery device illustrated in FIG. 4.

FIG. 6 is a perspective diagram illustrating a configuration example of an outer package can to be used in a process of manufacturing the secondary battery.

FIG. 7 is a perspective diagram illustrating a configuration example of a battery unit according to a modification example of the present disclosure.

FIG. 8 is an exploded perspective diagram illustrating a configuration example of a wiring unit illustrated in FIG. 7 in an unbent state.

### DETAILED DESCRIPTION

The present disclosure is described below in further detail including with reference to the drawings according to an embodiment.

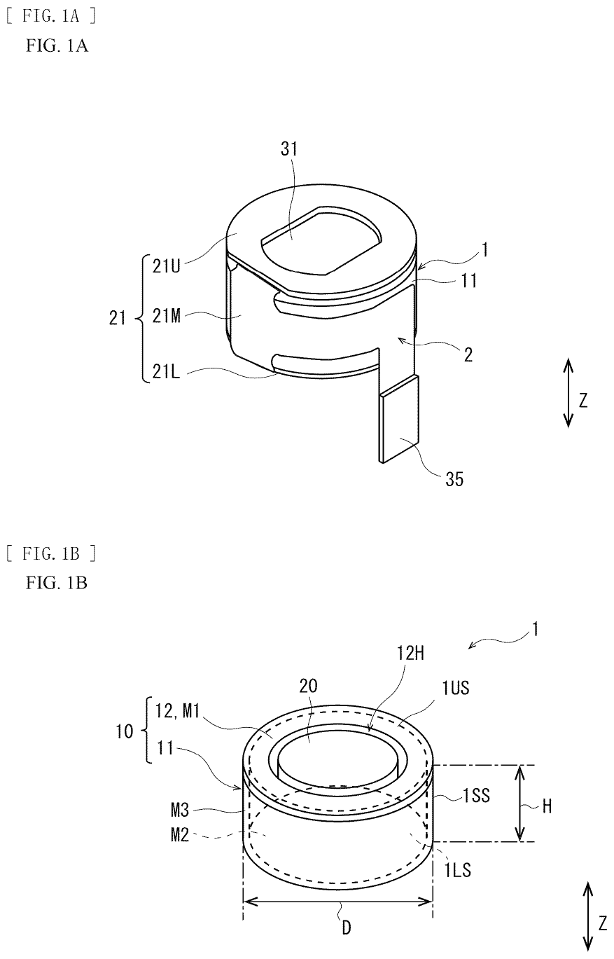

FIG. 1A is a perspective diagram illustrating an overall configuration example of a battery unit according to an embodiment of the present disclosure. As illustrated in FIG. 1A, the battery unit includes a secondary battery 1 and a wiring unit 2 attached to the secondary battery 1. Note that the battery unit preferably includes no circuit. As used herein, the circuit refers to a control circuit that controls, for example, a charging operation of the secondary battery 1.

The secondary battery to be described here has a flat and columnar three-dimensional shape, and is commonly referred to as, for example, a coin type or a button type. As will be described later, the secondary battery includes two bottom parts opposed to each other, and a sidewall part positioned between the two bottom parts. The secondary battery has a height smaller than an outer diameter. The “outer diameter” is a diameter (a maximum diameter) of each of the two bottom parts. The “height” is a distance (a maximum distance) from a surface of one of the bottom parts to a surface of another of the bottom parts. Note that, in the present embodiment, a direction from one of the bottom parts toward the other of the bottom parts is assumed to be a height direction Z.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case in which the electrode reactant is lithium. A secondary battery that obtains the battery capacity using insertion and extraction of lithium is what is called a lithium-ion secondary battery. In the lithium-ion secondary battery, lithium is inserted and extracted in an ionic state.

FIG. 1B is a perspective diagram illustrating a configuration example of an external appearance of the secondary battery 1 illustrated in FIG. 1A. For convenience, the following description is given with an upper side of a sheet plane of FIG. 1B assumed to be an upper side of the secondary battery, and a lower side of the sheet plane of FIG. 1B assumed to be a lower side of the secondary battery.

The secondary battery 1 to be described here has a three-dimensional shape in which a height H is smaller than an outer diameter D, as illustrated in FIG. 1B. In other words, the secondary battery 1 has a flat and columnar three-dimensional shape. Here, the three-dimensional shape of the secondary battery 1 is flat and cylindrical (circular columnar). Note that, in the present embodiment, an up-down direction on the sheet plane of FIG. 1B is assumed to be a height direction Z. Accordingly, the height H means a dimension, of the secondary battery 1, in the height direction Z. The outer diameter D means a dimension, of the secondary battery 1, in a direction orthogonal to the height direction Z. In other words, the outer diameter D means a dimension, of the secondary battery 1, in a direction in a horizontal plane.

Dimensions of the secondary battery 1 are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. In other words, the outer diameter D is greater than the height H. Although not particularly limited, an upper limit of the ratio D/H is preferably less than or equal to 25.

The secondary battery 1 includes an upper surface 1US, a lower surface 1LS, and a side surface 1SS. The lower surface ILS is on a side opposite to the upper surface 1US. The side surface 1SS couples the upper surface 1US and the lower surface ILS to each other. An external terminal 20 is exposed on the upper surface 1US. The external terminal 20 serves as a positive electrode terminal. A bottom part M2 of an outer package can 10 is exposed on the lower surface ILS. The bottom part M2 serves as a negative electrode terminal. The outer package can 10 includes a container part 11 and a cover part 12. The outer package can 10 extends from the lower surface 1LS, through the side surface 1SS, to an outer edge of the upper surface 1US. The external terminal 20 is surrounded by a peripheral part 12R (to be described later) of the cover part 12 on the upper surface 1US. The peripheral part 12R of the cover part 12 is a portion of the outer package can 10.

Note that a detailed configuration of the secondary battery 1 will be described later.

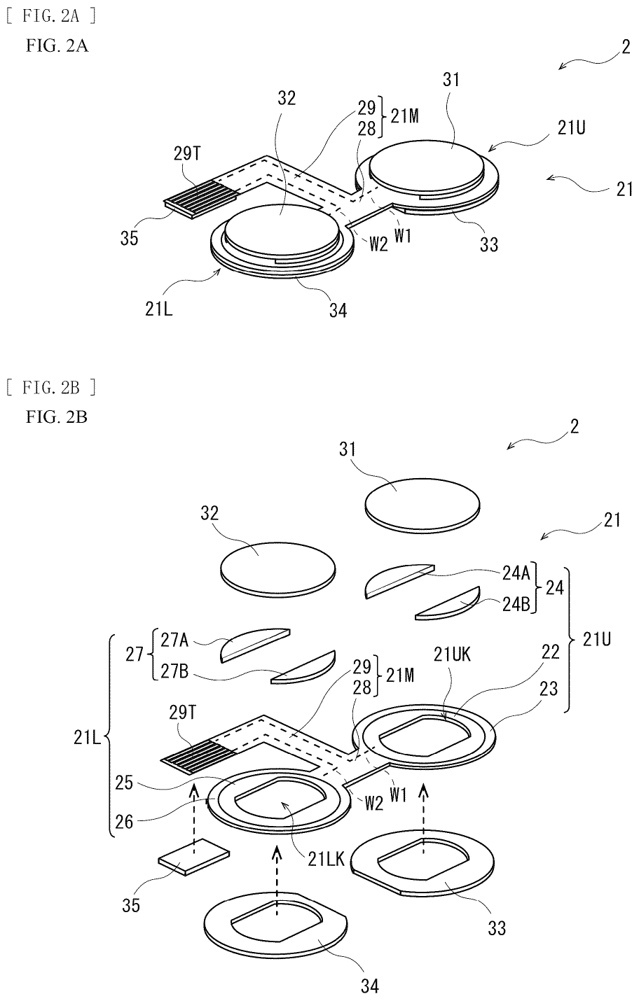

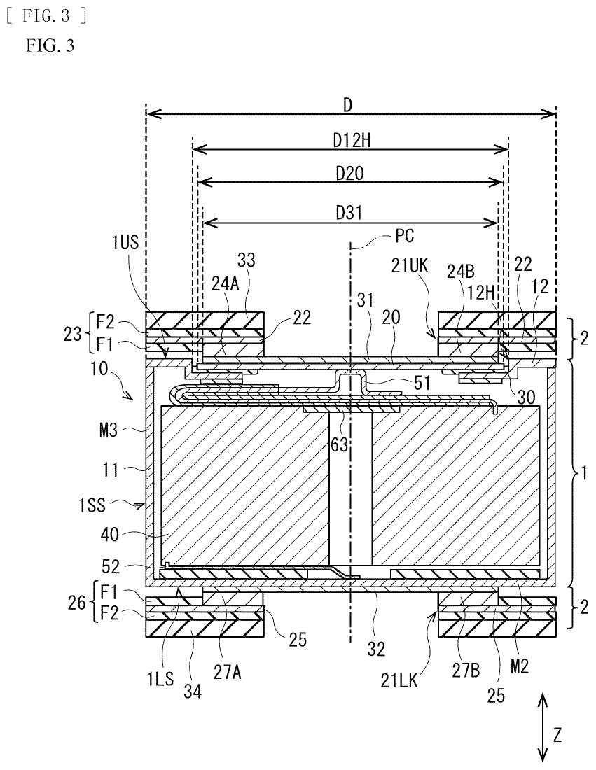

FIG. 2A is a perspective diagram illustrating a configuration example of the wiring unit 2 in an unbent state. FIG. 2B is an exploded perspective diagram of the wiring unit 2. The wiring unit 2 includes a first coupling terminal 31, a second coupling terminal 32, and a flexible wiring substrate 21. Further, FIG. 3 illustrates a sectional configuration example of the battery unit.

The first coupling terminal 31 is a thin plate that is disposed to face the external terminal 20 of the secondary battery 1 and welded to the external terminal 20. The thin plate includes an electrically conductive material. A material included in the first coupling terminal 31 may be the same as a material included in the external terminal 20. The second coupling terminal 32 is a thin plate that is disposed to face the bottom part M2 of the outer package can and welded to the bottom part M2. The bottom part M2 of the outer package can serves as the negative electrode terminal of the secondary battery 1. The thin plate includes an electrically conductive material. A material included in the second coupling terminal 32 may be the same as a material included in the bottom part M2.

The flexible wiring substrate 21 includes a first support part 21U, a second support part 21L, and a middle part 21M. The first support part 21U supports the first coupling terminal 31. The first support part 21U is provided to oppose the upper surface 1US of the secondary battery 1. The second support part 21L supports the second coupling terminal 32. The second support part 21L is provided to oppose the lower surface ILS of the secondary battery 1. The middle part 21M couples the first support part 21U and the second support part 21L to each other. The middle part 21M is provided along the side surface 1SS of the secondary battery 1. Note that, although FIGS. 2A and 2B illustrate the flexible wiring substrate 21 in an unbent state where all the first support part 21U, the second support part 21L, and the middle part 21M extend along the same plane, in the battery unit of an embodiment of the present disclosure, a boundary part between the first support part 21U and the middle part 21M is bent substantially vertically, and a boundary part between the second support part 21L and the middle part 21M is bent substantially vertically.

The flexible wiring substrate 21 further includes a first wire W1 and a second wire W2. The first wire W1 extends from the first coupling terminal 31, through the first support part 21U, to the middle part 21M. The second wire W2 extends from the second coupling terminal 32, through the second support part 21L, to the middle part 21M. The first wire W1 and the second wire W2 are sandwiched between, for example, two flexible insulating films (a first layer F1 and a second layer F2 to be described later).

The first support part 21U includes a first electrically conductive member 22, a first insulating member 23, and solder 24. The first electrically conductive member 22 is an annular electrically conductive member that is electrically coupled to an outer edge part of the first coupling terminal 31. The first support part 21U has an opening 21UK extending through the first insulating member 23 and the first electrically conductive member 22. Accordingly, as illustrated in FIG. 1A, a portion of the first coupling terminal 31 overlaps the opening 21UK and forms an exposed part exposed to an outside. Note that it is preferable that an outer diameter of the first support part 21U, or in particular, an outer diameter of the first insulating member 23 be substantially equal to the outer diameter D of the secondary battery 1.

The first electrically conductive member 22 and the first coupling terminal 31 may be coupled to each other by solder pieces 24A and 24B. Note that the electrical coupling between the first electrically conductive member 22 and the first coupling terminal 31 is not necessarily achieved by solder coupling. For example, the first electrically conductive member 22 and the first coupling terminal 31 may be electrically coupled to each other by welding. Further, the number of locations where the first electrically conductive member 22 and the first coupling terminal 31 are coupled to each other is not limited to two. The number of locations where the first electrically conductive member 22 and the first coupling terminal 31 are coupled to each other may be only one, or three or more. The first electrically conductive member 22 includes, for example, a metal foil such as a copper foil. The first insulating member 23 includes a frame-shaped insulating member that supports the first electrically conductive member 22. The first insulating member 23 includes a stacked structure of the first layer F1 and the second layer F2. As illustrated in FIG. 3, the first electrically conductive member 22 is sandwiched between the first layer F1 and the second layer F2, and a portion of the first electrically conductive member 22 is exposed to the peripheral part of the opening 21UK. The first layer F1 and the second layer F2 are each, for example, a flexible insulating film such as a polyimide film. As described earlier, the first wire W1 and the second wire W2 are provided between the first layer F1 and the second layer F2. As illustrated in FIG. 3, a portion of the first insulating member 23 is opposed to the peripheral part 12R of the cover part 12. The peripheral part 12R of the cover part 12 is located at the outer edge of the upper surface 1US and serves as the negative electrode terminal.

The middle part 21M includes a coupling part 28 and an extraction part 29. The coupling part 28 couples the first support part 21U and the second support part 21L to each other. The extraction part 29 branches from the coupling part 28. A coupling terminal 29T is provided on an end part, of the extraction part 29, opposite to the coupling part 28. The coupling part 28 and the extraction part 29 are integrated with each other and includes the stacked structure of the first layer F1 and the second layer F2 similarly to the first insulating member 23. The coupling part 28 and the extraction part 29 are provided with the first wire W1 and the second wire W2, which are sandwiched between the first layer F1 and the second layer F2. The first wire W1 and the second wire W2 are each coupled to the coupling terminal 29T.

The second support part 21L includes a second electrically conductive member 25, a second insulating member 26, and solder 27. The second electrically conductive member 25 is an annular electrically conductive member that is electrically coupled to an outer edge part of the second coupling terminal 32. The second support part 21L has an opening 21LK extending through the second insulating member 26 and the second electrically conductive member 25. Accordingly, a portion of the second coupling terminal 32 overlaps the opening 21LK and forms an exposed part exposed to the outside.

The second electrically conductive member 25 and the second coupling terminal 32 may be coupled to each other by solder pieces 27A and 27B. Note that the electrical coupling between the second electrically conductive member 25 and the second coupling terminal 32 is not necessarily achieved by solder coupling. For example, the second electrically conductive member 25 and the second coupling terminal 32 may be electrically coupled to each other by welding. Further, the number of locations where the second electrically conductive member 25 and the second coupling terminal 32 are coupled to each other is not limited to two. The number of locations where the second electrically conductive member 25 and the second coupling terminal 32 are coupled to each other may be only one, or three or more. The second electrically conductive member 25 includes, for example, a metal foil such as a copper foil. The second insulating member 26 includes a frame-shaped insulating member that supports the second electrically conductive member 25. As illustrated in FIG. 3, the second insulating member 26 includes the stacked structure of the first layer F1 and the second layer F2 similarly to the first insulating member 23. Specifically, the first insulating member 23, the second insulating member 26, the coupling part 28, and the extraction part 29 are integrated with each other. The second electrically conductive member 25 is sandwiched between the first layer F1 and the second layer F2, and a portion of the second electrically conductive member 25 is exposed to the peripheral part of the opening 21LK.

The wiring unit 2 further includes a first reinforcing member 33, a second reinforcing member 34, and a third reinforcing member 35. The first reinforcing member 33 is positioned on an opposite side of the first support part 21U from the upper surface 1US and is fixed to the first support part 21U. The second reinforcing member 34 is positioned on an opposite side of the second support part 21L from the lower surface ILS and is fixed to the second support part 21L. The third reinforcing member 35 is provided on a back surface of the coupling terminal 29T. The first reinforcing member 33, the second reinforcing member 34, and the third reinforcing member 35 each has an insulating property. The first reinforcing member 33, the second reinforcing member 34, and the third reinforcing member 35 may include, for example, an insulating material having high hardness such as a glass epoxy substrate. Note that it is preferable that an outer diameter of the first reinforcing member 33 be substantially equal to the outer diameter D of the secondary battery 1.

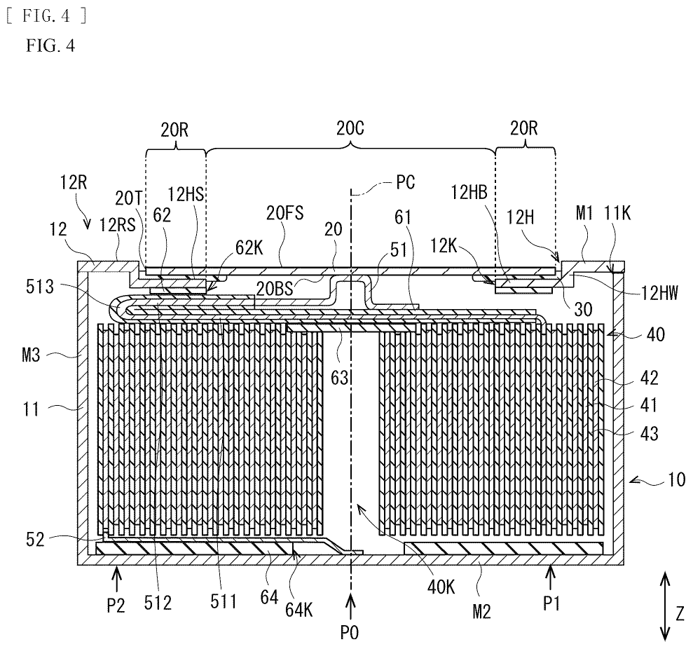

FIG. 4 is a sectional diagram illustrating a detailed configuration example of the secondary battery 1. As illustrated in FIG. 4, the secondary battery 1 includes the outer package can 10, the external terminal 20, a gasket 30, a battery device 40, a positive electrode lead 51, a negative electrode lead 52, a sealant 61, insulating films 62 and 63.

The outer package can 10 is a hollow outer package member that contains the battery device 40 and other components. The outer package can 10 includes an electrically conductive material such as metal.

The outer package can 10 has a flat and circular columnar three-dimensional shape corresponding to the three-dimensional shape of the secondary battery that is flat and circular columnar. The outer package can 10 includes two bottom parts M1 and M2 opposed to each other, and a sidewall part M3 positioned between the bottom parts M1 and M2. In other words, the sidewall part M3 couples the bottom part M1 and the bottom part M2 to each other and surrounds the battery device 40. The sidewall part M3 has an upper end part coupled to the bottom part M1. The sidewall part M3 has a lower end part coupled to the bottom part M2. As described above, the outer package can 10 is substantially circular columnar. Thus, the bottom parts M1 and M2 are each substantially circular in plan shape, and a surface of the sidewall part M3 is a convexly curved surface.

The outer package can 10 includes the container part 11 and the cover part 12 that are welded to each other. In other words, an internal space of the outer package can 10 is sealed by the cover part 12 being welded to the container part 11. Note that, in the present embodiment, the bottom part Ml forms the cover part 12, and the bottom part M2 and the sidewall part M3 are integrated to form the container part 11. Accordingly, an outer edge of the cover part 12 is welded to an end part, of the sidewall part M3, opposite to the bottom part M2, that is, the upper end part of the sidewall part M3.

The container part 11 is a container member that is to contain the battery device 40 and other components inside, and has a flat and circular columnar shape. The container part 11 has a hollow structure with an upper end part open and a lower end part closed. In other words, the container part 11 has an opening 11K at the upper end part. The opening 11K serves as a passing-through hole through which the battery device 40 is passable in the height direction Z.

As illustrated in FIG. 4, the cover part 12 is a substantially disk-shaped cover member that closes the opening 11K of the container part 11, and has a through hole 12K. The through hole 12K is used as a coupling path for coupling the battery device 40 and the external terminal 20 to each other. The outer edge of the cover part 12 is welded to the opening 11K of the container part 11, as described above. The external terminal 20 is attached to the cover part 12 with the gasket 30 interposed therebetween. That is, the cover part 12 supports the external terminal 20 with the gasket 30 interposed therebetween. The external terminal 20 is attached to the cover part 12, with the gasket 30 interposed therebetween, at a position overlapping the through hole 12K of the cover part 12 in the height direction Z. The external terminal 20 is electrically insulated from the outer package can 10.

In the secondary battery after completion, the cover part 12 is in a state of being welded to the container part 11 as described above. The opening 11K is closed with use of the cover part 12 as described above. It may thus seem that whether the container part 11 has had the opening 11K is no longer recognizable from an external appearance of the secondary battery.

In the secondary battery after completion, the cover part 12 is in a state of being welded to the container part 11 as described above. The opening 11K is closed with use of the cover part 12 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Thus, whether the container part 11 has had the opening 11K is recognizable afterward based on the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

The cover part 12 is so bent as to partly protrude along the height direction Z toward an inside of the container part 11 and thus forms a recessed part 12H. Specifically, as viewed from outside the outer package can 10, the cover part 12 is shaped to be partly recessed in the height direction Z toward the battery device 40 contained inside the outer package can 10. The recessed part 12H has the through hole 12K extending in the height direction Z, a bottom part 12HB surrounding the through hole 12K along a horizontal plane orthogonal to the height direction Z, and a wall part 12HW provided upright along an outer edge of the bottom part 12HB. A portion of the cover part 12 other than the recessed part 12H is the peripheral part 12R. The peripheral part 12R is provided to surround the recessed part 12H and has an annular shape in the horizontal plane orthogonal to the height direction Z of the secondary battery. The peripheral part 12R is a portion that surrounds a periphery of the recessed part 12H and protrudes away from the battery device 40 along the height direction Z. Accordingly, a surface 12HS of the bottom part 12HB of the recessed part 12H is at a low position in the height direction Z toward the inside of the container part 11 as compared with a surface 12RS of the peripheral part 12R. In other words, a distance between the surface 12HS of the bottom part 12HB of the recessed part 12H and the battery device 40 in the height direction Z is shorter than a distance between the surface 12RS of the peripheral part 12R and the battery device 40 in the height direction Z.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter D12H and a depth of the recessed part 12H are each not particularly limited and may be set as desired. However, the depth of the recessed part 12H is set to allow a height position of a surface 20S of the external terminal 20 to be lower than a height position of the surface 12RS of the peripheral part 12R, in a state where the external terminal 20 is attached to the recessed part 12H with the gasket 30 interposed therebetween. Additionally, the inner diameter D12H of the recessed part 12H is set to be greater than an outer diameter D20 of the external terminal 20.

As described above, the outer package can 10 is what is called a welded can in which the container part 11 and the cover part 12 that have been physically separate from each other are welded to each other. Thus, the outer package can 10 after the welding is a single member that is physically integral as a whole, and is in a state of being not separable into the container part 11 and the cover part 12 afterward.

The outer package can 10 that is the welded can is different from a crimped can formed by crimping processing, and is what is called a crimpless can. One reason for this is to increase a device space volume inside the outer package can 10 and to thereby increase an energy density per unit volume. The “device space volume” refers to a volume (an effective volume) of the internal space of the outer package can 10 available for containing the battery device 40.

Further, the outer package can 10 that is the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable from each other afterward.

Here, the outer package can 10 is electrically conductive. To be more specific, the container part 11 and the cover part 12 are each electrically conductive. The outer package can 10 is electrically coupled to a negative electrode 42 of the battery device 40 via the negative electrode lead 52. Accordingly, the outer package can 10 also serves as an external coupling terminal of the negative electrode 42. It is unnecessary for the secondary battery 1 of the present embodiment to be provided with the external coupling terminal of the negative electrode 42 separate from the outer package can 10, which suppresses a decrease in the device space volume resulting from providing the external coupling terminal of the negative electrode 42. As a result, the device space volume increases, and the energy density per unit volume increases accordingly.

Specifically, the outer package can 10 is a metal can that includes any one or more of electrically conductive materials including, without limitation, a metal material and an alloy material. Examples of the electrically conductive material included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

The cover part 12 is insulated, via the gasket 30, from the external terminal 20 serving as an external coupling terminal of a positive electrode 41. One reason for this is to prevent contact, or a short circuit, between the outer package can 10 that is the external coupling terminal of the negative electrode 42 and the external terminal 20 that is the external coupling terminal of the positive electrode 41.

As illustrated in FIGS. 1B, 3, and 4, the external terminal 20 is a coupling terminal to be coupled to electronic equipment via the wiring unit 2 when the secondary battery 1 is mounted on the electronic equipment. As described above, the external terminal 20 is attached to the cover part 12 of the outer package can 10 to be supported by the cover part 12.

The external terminal 20 is coupled to the positive electrode 41 of the battery device 40 via the positive electrode lead 51. The external terminal 20 thus also serves as the external coupling terminal of the positive electrode 41. Accordingly, upon use of the secondary battery 1, the external terminal 20 serving as the external coupling terminal of the positive electrode 41 and the outer package can 10 serving as the external coupling terminal of the negative electrode 42 are coupled to electronic equipment via the wiring unit 2. This allows the electronic equipment to operate with use of the secondary battery 1 as a power source.

The external terminal 20 is a substantially plate-shaped member that is flat and extend along a horizontal plane orthogonal to the height direction Z of the secondary battery. A shape of the external terminal 20 in a plan view, that is, a shape defined by an outer edge of the external terminal 20 when the secondary battery is viewed from above, is not particularly limited. In the secondary battery 1 according to the present embodiment, the shape of the external terminal 20 in a plan view is substantially circular. The external terminal 20 is disposed inside the recessed part 12H with the gasket 30 interposed therebetween. In other words, the external terminal 20 is provided in a state of being contained in the recessed part 12H without protruding from the recessed part 12H in the height direction Z. Accordingly, as illustrated in FIG. 3, the outer diameter D20 of the external terminal 20 is smaller than the inner diameter D12H of the recessed part 12H in a section along the height direction Z. Similarly, an outer diameter D31 of the first coupling terminal 31 of the wiring unit 2 is also smaller than the inner diameter D12H of the recessed part 12H. A center position of the external terminal 20 preferably match with a center line PC (to be described later) of the secondary battery.

The external terminal 20 is insulated from the cover part 12 via the gasket 30. Here, as illustrated in FIG. 4, a position of the surface 20FS of the external terminal 20 is low in the height direction Z toward the battery device 40 as compared with a position of the surface 12RS of the peripheral part 12R of the outer package can 10 in the height direction Z even at the highest position of the surface 20FS. In the secondary battery 1 of the present embodiment, the height of the secondary battery 1 is reduced as compared with a case where the external terminal 20 protrudes above the cover part 12. This increases the energy density per unit volume of the secondary battery 1. This also makes it possible to prevent a short circuit between the outer package can 10 and the external terminal 20 from being caused by another electrically conductive member. The external terminal 20 includes a middle part 20C and a peripheral part 20R. The peripheral part 20R surrounds the middle part. The middle part 20C is a part of the external terminal 20 that overlaps the through hole 12K of the cover part 12. The positive electrode lead 51 is coupled to a back surface 20BS of the middle part 20C. The peripheral part 20R overlaps the bottom part 12HB of the recessed part 12H in the height direction Z. Owing to the external terminal 20 and the cover part 12 having an overlap portion, it is possible to improve mechanical strength of the secondary battery as a whole.

Note that, the outer diameter D20 of the external terminal 20 is smaller than the inner diameter D12H of the recessed part 12H (D20<D12H) as illustrated in FIG. 2, and thus an outer edge 20T of the external terminal 20 is spaced from the cover part 12 as illustrated in FIG. 4. Accordingly, the gasket 30 is disposed in only a portion of a region between the external terminal 20 and the cover part 12 (the recessed part 12H). More specifically, the gasket 30 is disposed only at a location where the external terminal 20 and the cover part 12 would be in contact with each other if it were not for the gasket 30. However, the gasket 30 may also be provided between an inner wall face of the wall part 12HW of the recessed part 12H and the outer edge 20T of the external terminal 20.

The external terminal 20 includes any one or more of electrically conductive materials including, without limitation, a metal material and an alloy material. The external terminal 20 may include a single layer or may include a stacked body including two or more layers having different linear expansion coefficients from each other, for example. Specifically, the external terminal 20 may be a stacked body of a first layer including Ni (nickel), a second layer including stainless steel such as SUS304, and a third layer including Al (aluminum).

The gasket 30 is an insulating member disposed between the outer package can 10 (the cover part 12) and the external terminal 20 as illustrated in FIG. 2. The external terminal 20 is fixed to the cover part 12 with the gasket 30 interposed therebetween. The gasket 30 is ring-shaped in a plan view and has a through hole at a location corresponding to the through hole 12K. The gasket 30 includes any one or more of insulating materials including, without limitation, a polymer compound having an insulating property. The insulating materials are resins including, without limitation, polypropylene and polyethylene.

A range of placement of the gasket 30 may be chosen as desired. Here, the gasket 30 is disposed in a gap between the surface 12HS of the bottom part 12HB of the recessed part 12H and the back surface 20BS of the external terminal 20. However, as described above, the gasket 30 is preferably also provided between the inner wall face of the wall part 12HW of the recessed part 12H and the outer edge 20T of the external terminal 20. Further, the cover part 12 and the external terminal 20 are preferably stuck to each other by the gasket 30.

The battery device 40 is a power generation device that causes charging and discharging reactions to proceed. As illustrated in FIGS. 3 and 4, the battery device 40 is contained inside the outer package can 10. As illustrated in FIG. 4, the battery device 40 includes the positive electrode 41 and the negative electrode 42. The positive electrode 41 serves as a first electrode. The negative electrode 42 serves as a second electrode. Here, the battery device 40 further includes a separator 43 and an electrolytic solution. The electrolytic solution is a liquid electrolyte.

The center line PC illustrated in FIG. 4 is a line segment corresponding to a center of the battery device 40 in a direction along the outer diameter D of the secondary battery (the outer package can 10 of the secondary battery). More specifically, a position P of the center line PC corresponds to a position of the center of the battery device 40.

The battery device 40 is what is called an electrode wound body. More specifically, in the battery device 40, the positive electrode 41 and the negative electrode 42 are stacked on each other with the separator 43 interposed between the positive electrode 41 and the negative electrode 42. In addition, the stack of the positive electrode 41, the negative electrode 42, and the separator 43 is wound around the center line PC that is a winding axis. The positive electrode 41 and the negative electrode 42 are wound, remaining in a state of being opposed to each other with the separator 43 interposed between the positive electrode 41 and the negative electrode 42. As a result, a winding center space 40K serving as an internal space is present at the center of the battery device 40.

Here, the positive electrode 41, the negative electrode 42, and the separator 43 are so wound that the separator 43 is disposed in each of an outermost wind of the electrode wound body and an innermost wind of the electrode wound body. Respective numbers of winds of the positive electrode 41, the negative electrode 42, and the separator 43 are not particularly limited, and may be chosen as desired.

The battery device 40 has a three-dimensional shape based on the three-dimensional shape of the outer package can 10. Specifically, the battery device 40 has a flat and circular columnar three-dimensional shape. This helps to prevent what is called a dead space, more specifically, a gap between the outer package can 10 and the battery device 40, from easily being provided when the battery device 40 is placed inside the outer package can 10, as compared with a case where the battery device 40 has a three-dimensional shape different from the three-dimensional shape of the outer package can 10. This allows for efficient use of the internal space of the outer package can 10. As a result, the device space volume increases, and the energy density per unit volume of the secondary battery increases accordingly.

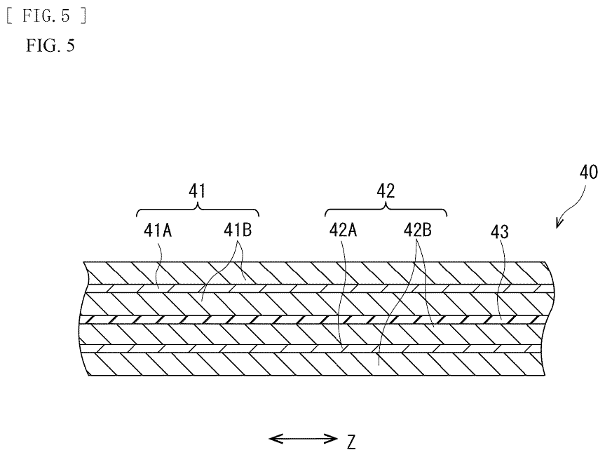

FIG. 5 is a sectional diagram illustrating a configuration example of a portion of the battery device 40. The positive electrode 41 is the first electrode to be used to cause the charging and discharging reactions to proceed. As illustrated in FIG. 5, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. One reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 42 is the second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A. The negative electrode active material layer 42B may further include other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. One reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. One reason for this is to prevent precipitation of lithium extracted from the positive electrode 41. The “height” is a dimension corresponding to the height H of the secondary battery described above, that is, a dimension in the up-down direction in each of FIGS. 1 and 2. The definition of the height described here applies also to the following.

The separator 43 is an insulating porous film interposed between the positive electrode 41 and the negative electrode 42, as illustrated in FIGS. 4 and 5. The separator 43 allows lithium ions to pass through the separator 43 and prevents a short circuit between the positive electrode 41 and the negative electrode 42. The separator 43 includes a polymer compound such as polyethylene.

Here, the separator 43 has a height greater than the height of the negative electrode 42. More specifically, the separator 43 preferably protrudes above the negative electrode 42 and protrudes below the negative electrode 42. One reason for this is to insulate the positive electrode lead 51 from the negative electrode 42 by using the separator 43.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 4, the positive electrode lead 51 is contained inside the outer package can 10. The positive electrode lead 51 is coupling wiring coupled to each of the positive electrode 41 and the external terminal 20. The secondary battery illustrated in FIG. 2 includes one positive electrode lead 51. However, the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to the back surface 20BS of the external terminal 20 through the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. As illustrated in FIG. 2, the positive electrode lead 51 includes a first part 511, a second part 512, and a turning part 513. The first part 511 and the second part 512 each extend along a horizontal plane orthogonal to the height direction Z of the secondary battery. Further, the first part 511 and the second part 512 overlap each other in the height direction Z of the secondary battery, with the sealant 61 interposed between the first part 511 and the second part 512. The turning part 513 is so curved as to couple the first part 511 and the second part 512 to each other.

The first part 511 and the second part 512 are sandwiched between the battery device 40 and the recessed part 12H of the cover part 12 in the height direction Z of the secondary battery.

In this way, the portion of the positive electrode lead 51 is held by the cover part 12 and the battery device 40 by extending along each of a lower surface of the cover part 12 and an upper surface of the battery device 40. This allows the positive electrode lead 51 to be fixed inside the outer package can 10. By preventing the positive electrode lead 51 from easily moving even if the secondary battery experiences an external force such as vibration or impact, the positive electrode lead 51 is prevented from being easily damaged. Examples of damage to the positive electrode lead 51 include cracking of the positive electrode lead 51, breakage of the positive electrode lead 51, and detachment of the positive electrode lead 51 from the positive electrode 41.

More specifically, the wording “a portion of the positive electrode lead 51 is sandwiched by the outer package can 10 and the battery device 40” means that the positive electrode lead 51 is held by the outer package can 10 and the battery device 40 from above and below while being insulated from each of the outer package can 10 and the battery device 40, and that the positive electrode lead 51 is thus in a state of being not easily movable inside the outer package can 10 even if the secondary battery experiences an external force such as vibration or impact. The state where the positive electrode lead 51 is not easily movable inside the outer package can 10 exactly indicates that the battery device 40 is also in the state of being not easily movable inside the outer package can 10. This helps to also suppress a defect of the battery device 40, i.e., the electrode wound body, such as winding deformation when the secondary battery experiences vibration or impact.

Note that the positive electrode lead 51 may be in a state of being partially embedded in the battery device 40 because of being pressed by the battery device 40. More specifically, the positive electrode lead 51 may be in a state of being partially embedded in an upper end part of the separator 43 because of the height of the separator 43 being greater than the height of each of the positive electrode 41 and the negative electrode 42 as described above. In such a case, a recessed part is formed in the upper end part of the separator 43 because of being pressed by the positive electrode lead 51. All or a part of the positive electrode lead 51 is received in the recessed part, which allows the positive electrode lead 51 to be held by the separator 43. This further prevents the positive electrode lead 51 from easily moving inside the outer package can 10, and to thereby further prevent the positive electrode lead 51 from being easily damaged.

Here, as described above, the cover part 12 includes the protruding part 12P, and a portion of the positive electrode lead 51 is sandwiched by the protruding part 12P and the battery device 40. More specifically, a portion of the positive electrode lead 51 is held by the protruding part 12P and the battery device 40 by extending along each of a lower surface of the protruding part 12P and the upper surface of the battery device 40. The protruding part 12P helps to hold the positive electrode lead 51 more easily. This further prevents the positive electrode lead 51 from being easily damaged.

Further, a portion of the positive electrode lead 51 is insulated from the cover part 12 and the negative electrode 42 via each of the separator 43, the sealant 61, and the insulating film 62.

Specifically, as described above, the height of the separator 43 is greater than the height of the negative electrode 42. Accordingly, a portion of the positive electrode lead 51 is separate from the negative electrode 42 via the separator 43, and is thus insulated from the negative electrode 42 via the separator 43. One reason for this is to prevent a short circuit between the positive electrode lead 51 and the negative electrode 42.

Further, the positive electrode lead 51 is covered at a periphery thereof by the sealant 61 having an insulating property. A portion of the positive electrode lead 51 is thus insulated from each of the cover part 12 and the negative electrode 42 via the sealant 61. One reason for this is to prevent a short circuit between the positive electrode lead 51 and the cover part 12, and to also prevent a short circuit between the positive electrode lead 51 and the negative electrode 42.

Further, the insulating film 62 is disposed between the cover part 12 and the positive electrode lead 51. A portion of the positive electrode lead 51 is thus insulated from the cover part 12 via the insulating film 62. One reason for this is to prevent a short circuit between the positive electrode lead 51 and the cover part 12.

Furthermore, the insulating film may also be disposed between the battery device 40 and the positive electrode lead 51.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

Here, the positive electrode lead 51 is coupled to the positive electrode 41 in a region on a front side relative to the center line PC, i.e., a region on a right side relative to the center line PC in FIG. 4. In order to be coupled to the external terminal 20, the positive electrode lead 51 includes the turning part 513 in the middle of extension to the external terminal 20. The turning part 513 is present in a region on a back side relative to the center line PC, i.e., a region on a left side relative to the center line PC in FIG. 4. The positive electrode lead 51 includes the first part 511 that corresponds to a part extending from a location where the positive electrode lead 51 is coupled to the positive electrode 41, through the center position P, to the turning part 513. The first part 511 extends along the upper surface of the battery device 40 in a direction orthogonal to the height direction Z. In addition, the positive electrode lead 51 includes the second part 512 that corresponds to a part in the middle of extension from the turning part 513 to a location where the positive electrode lead 51 is coupled to the external terminal 20. The second part 512 extends along the upper surface of the battery device 40 in the direction orthogonal to the height direction Z to be laid over the first part 511. As described above, a portion of the positive electrode lead 51 is sandwiched by the cover part 12 and the battery device 40 and extends toward the external terminal 20, in both the region on the front side relative to the center line PC and the region on the back side relative to the center line PC.

Here, as is apparent from FIG. 4, “the region on the front side relative to the center line PC” is, where the battery device 40 is divided into two regions with respect to the center line PC in a direction along the outer diameter D, one region in which the location where the positive electrode lead 51 is coupled to the positive electrode 41 is present. In FIG. 4, “the region on the front side relative to the center line PC” is the region on the right side relative to the center line PC. In contrast, as is apparent from FIG. 4, “the region on the back side relative to the center line PC” is another region of the two regions, and is the region on the left side relative to the center line PC in FIG. 4. In other words, “the region on the back side relative to the center line PC” is, where the battery device 40 is divided into the two regions with respect to the center line PC in the direction along the outer diameter D, the other region in which the location where the positive electrode lead 51 is coupled to the positive electrode 41 is absent.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to an outermost wind of the positive electrode 41. One reason for this is that corrosion of the outer package can 10 caused by creeping up of the electrolytic solution is suppressed unlike when the positive electrode lead 51 is coupled to the positive electrode 41 in the outermost wind of the positive electrode 41. The “creeping up of the electrolytic solution” refers to a phenomenon in which, when the positive electrode lead 51 is disposed adjacent to an inner wall face of the outer package can 10, the electrolytic solution in the battery device 40 creeps up along the positive electrode lead 51 to reach the inner wall face of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the extending direction of the positive electrode lead 51 changes at an angle greater than 90° in the middle of the positive electrode lead 51. The positive electrode lead 51 preferably has, at a location where the positive electrode lead 51 is turned up, a curved shape rather than a bent shape, as with the turning part 513. Further, although FIG. 4 illustrates an example in which the positive electrode lead 51 includes one turning part 513, the positive electrode lead 51 may include multiple turning parts 513.

The positive electrode lead 51 is turned up at the turning part 513 in the middle of extension from the positive electrode 41 to the external terminal 20. Specifically, as illustrated in FIG. 2, the first part 511 extends from a first position Pl to a second position P2 in a horizontal plane orthogonal to the height direction of the secondary battery. The first position P1 is other than the center position P of the outer package can 10. The second position P2 is on an opposite side of the center position to the first position P1. The second part 512 extends from the second position P2 toward the center position P. In the positive electrode lead 51, an overlap portion of the first part 511 and the second part 512 is a surplus portion. It can thus be said that the positive electrode lead 51 has a length margin in a longitudinal direction of the positive electrode lead 51.

This provides room to change an orientation of the cover part 12 relative to the container part 11 when forming the outer package can 10 by using the container part 11 and the cover part 12 in a process of manufacturing the secondary battery, as will be described later. Further, when the secondary battery experiences an external force such as vibration or impact, the length margin of the positive electrode lead 51 is usable to mitigate the external force, thereby helping to prevent the positive electrode lead 51 from being easily damaged. Furthermore, the length margin of the positive electrode lead 51 is usable to change the position of coupling of the positive electrode lead 51 to the positive electrode 41 to a desired position without changing the positive electrode lead 51 in length.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. One reason for this is to ensure that the length of the positive electrode lead 51 has a length margin allowing for raising the cover part 12 relative to the container part 11, and to thereby make it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from easily becoming detached from the external terminal 20 and be narrow enough to allow for the length margin of the positive electrode lead 51, in particular. One reason why the range of coupling of the positive electrode lead 51 to the external terminal 20 is preferably narrow enough is that a sufficiently large length margin of the positive electrode lead 51 is achievable because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be integrated with the positive electrode current collector 41A.

As illustrated in FIG. 4, the negative electrode lead 52 is contained inside the outer package can 10. The negative electrode lead 52 is coupled to each of the negative electrode 42 and the outer package can 10 (the container part 11). Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. Details of a method of coupling the negative electrode lead 52 are similar to the details of the method of coupling the positive electrode lead 51.

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

A position of coupling of the negative electrode lead 52 to the negative electrode 42 is not particularly limited, and may be chosen as desired. Here, the negative electrode lead 52 is coupled to an outermost wind part of the negative electrode 42 included in the electrode wound body.

Note that the negative electrode lead 52 is provided separately from the negative electrode current collector 42A. However, the negative electrode lead 52 may be physically continuous with the negative electrode current collector 42A and may thus be integrated with the negative electrode current collector 42A.

The sealant 61 is a first insulating member covering the periphery of the positive electrode lead 51, as illustrated in FIG. 4. The sealant 61 includes two insulating tapes each being attached to corresponding one of a front surface and a back surface of the positive electrode lead 51. Here, to allow the positive electrode lead 51 to be coupled to each of the positive electrode 41 and the external terminal 20, the sealant 61 covers the periphery of a portion in the middle of the positive electrode lead 51. Note that a structure of the sealant 61 is not limited to a tape-shaped structure, and the sealant 61 may have a tube-shaped structure, for example.

The sealant 61 includes any one or more of insulating materials including, without limitation, a polymer compound having an insulating property. Examples of the insulating materials include polyimide.

The insulating film 62 is disposed between the cover part 12 and the positive electrode lead 51 in the height direction Z, as illustrated in FIG. 4. Here, the insulating film 62 is ring-shaped in a plan view and has an opening 62K at a location corresponding to the through hole 12K in the height direction Z.

The insulating film 62 may have an unillustrated adhesive layer on one surface, and may thus be adhered to either the cover part 12 or the positive electrode lead 51 via the adhesive layer.

Alternatively, the insulating film 62 may have respective adhesive layers on both surfaces, and may thus be adhered to both the cover part 12 and the positive electrode lead 51 via the respective adhesive layers.

The insulating film 62 may include any one or more of insulating materials including, without limitation, a polymer compound having an insulating property. Examples of the one or more insulating materials to be included in the insulating film 62 include polyimide.

The insulating film 63 is a third insulating member disposed between the battery device 40 and the positive electrode lead 51, as illustrated in FIG. 4. Here, the insulating film 63 is flat plate-shaped in a plan view. The insulating film 63 is disposed to close the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same as or different from each other.

Note that the secondary battery 1 may further include one or more other components.

Specifically, the secondary battery 1 includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include the occurrence of a short circuit inside the secondary battery 1 and heating of the secondary battery from outside. Although a placement location of the safety valve mechanism is not particularly limited, the safety valve mechanism is preferably placed on either the bottom part M1 or the bottom part M2, and more preferably, on the bottom part M2 to which no external terminal 20 is attached, in particular.

Further, the secondary battery may include an insulator between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part Ml or the bottom part M2, and more preferably, on the bottom part M2, in particular, as with the placement location of the safety valve mechanism described above.

Upon charging of the secondary battery 1, in the battery device 40, lithium is extracted from the positive electrode 41, and the extracted lithium is inserted into the negative electrode 42 through the electrolytic solution. Upon discharging of the secondary battery, in the battery device 40, lithium is extracted from the negative electrode 42, and the extracted lithium is inserted into the positive electrode 41 through the electrolytic solution. Upon the charging and the discharging, lithium is inserted and extracted in an ionic state.

A description is given next of a method of manufacturing the battery unit according to an embodiment.

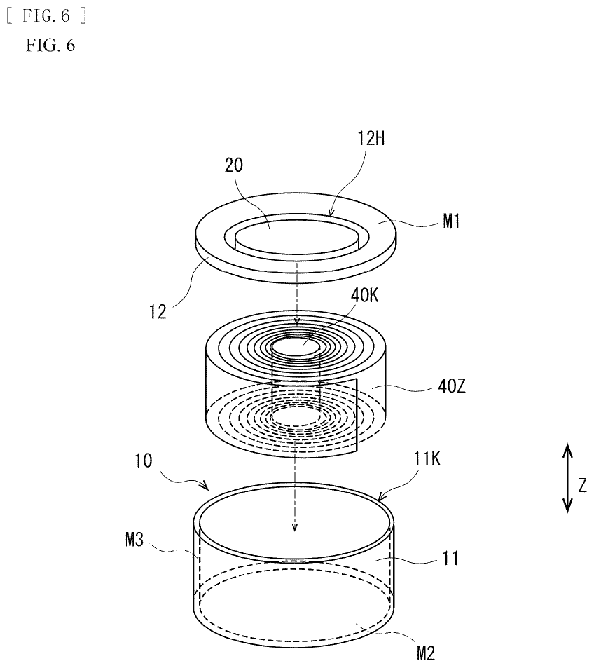

A description is given first of a method of manufacturing the secondary battery 1. FIG. 6 illustrates a perspective configuration of the outer package can 10 to be used in the process of manufacturing the secondary battery 1, and corresponds to FIG. 1B.

FIG. 6 illustrates a state where the cover part 12 is separate from the container part 11 before the cover part 12 is welded to the container part 11. In the following description, where appropriate, FIGS. 1A to 5 described already will be referred to in conjunction with FIG. 6.

Here, as illustrated in FIG. 6, the container part 11 and the cover part 12 that are physically separate from each other are prepared to form the outer package can 10. The container part 11 is a substantially bowl-shaped member in which a bottom part 11B and a sidewall part 11W are integrated with each other, and has the opening 11K. Alternatively, the bottom part 11B and the sidewall part 11W that are physically separate from each other may be prepared, and the sidewall part 11W may be welded to the bottom part 11B to thereby form the container part 11. A convex part 11P is provided on an inner side of the sidewall part 11W. The convex part 11P is formed integrally with, for example, the sidewall part 11W. Alternatively, the convex part 11P that is formed separately from the sidewall part 11W may be attached to the inner side of the sidewall part 11W.

The cover part 12 is a substantially plate-shaped member corresponding to the bottom part M1. As will be described later, the external terminal 20 is attached in advance to the lower surface of the cover part 12 with the gasket 30 (omitted in FIG. 6) interposed between the external terminal 20 and the cover part 12.

First, the positive electrode active material and other materials including, without limitation, the positive electrode binder and the positive electrode conductor are mixed with each other to thereby produce a positive electrode mixture. Thereafter, the positive electrode mixture thus produced is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated by a procedure similar to the fabrication procedure of the positive electrode 41. Specifically, after the negative electrode current collector 42A has been prepared, a negative electrode mixture, which is a mixture of the negative electrode active material and other materials including, without limitation, the negative electrode binder and the negative electrode conductor with each other, is put into an organic solvent to thereby prepare a negative electrode mixture slurry in paste form. Both end parts, in the width direction, of the negative electrode current collector 42A are slightly bent in the same direction to thereby form an upper end part 42U and a lower end part 42L. Thereafter, the negative electrode mixture slurry is applied on the two opposed surfaces of the negative electrode current collector 42A to thereby form the negative electrode active material layers 42B. Thereafter, the negative electrode active material layers 42B are compression-molded by, for example, a roll pressing machine. In this manner, the negative electrode 42 is fabricated.

The electrolyte salt is put into the solvent. The electrolyte salt is thereby dispersed or dissolved in the solvent. Thus, the electrolytic solution is prepared.

First, using the welding method such as the resistance welding method, the positive electrode lead 51 covered at the periphery thereof by the sealant 61 is coupled to the positive electrode 41 (the positive electrode current collector 41A), and the negative electrode lead 52 is coupled to the negative electrode 42 (the negative electrode current collector 42A).

Thereafter, the positive electrode 41 and the negative electrode 42 are stacked on each other with the separator 43 interposed between the positive electrode 41 and the negative electrode 42, following which the stacked body including the positive electrode 41, the negative electrode 42, and the separator 43 is wound to thereby fabricate a wound body 40Z, as illustrated in FIG. 4. The wound body 40Z has a configuration similar to the configuration of the battery device 40 except that the positive electrode 41, the negative electrode 42, and the separator 43 are each unimpregnated with the electrolytic solution. Note that FIG. 4 omits the illustration of each of the positive electrode lead 51 and the negative electrode lead 52.

Thereafter, the wound body 40Z to which the positive electrode lead 51 and the negative electrode lead 52 are each coupled is placed into the container part 11 through the opening 11K. In placing the wound body 40Z in the container part 11, the wound body 40Z is placed in a space below the convex part 11P, that is, a space between the convex part 11P and the bottom part 11B in the height direction Z. In this case, the negative electrode lead 52 is coupled to the container part 11 by the welding method such as the resistance welding method. Thereafter, the insulating film 63 is placed on the wound body 40Z.

Thereafter, the cover part 12 to which the external terminal 20 is attached in advance with the gasket 30 being interposed between the cover part 12 and the external terminal 20 and on which the insulating film 62 is provided in advance is prepared, following which the positive electrode lead 51 is coupled to the external terminal 20 through the through hole 12K by the welding method such as the resistance welding method.

As a result, the wound body 40Z (the positive electrode 41) contained inside the container part 11 and the external terminal 20 attached to the cover part 12 are coupled to each other via the positive electrode lead 51.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even with the battery device 40 and the external terminal 20 being coupled to each other via the positive electrode lead 51. The wound body 40Z including the positive electrode 41, the negative electrode 42, and the separator 43 is thereby impregnated with the electrolytic solution. Thus, the battery device 40, i.e., the electrode wound body, is fabricated.

Thereafter, the cover part 12 is brought down to approach the container part 11 to thereby close the opening 11K with the cover part 12, following which the cover part 12 is welded to the container part 11 by the welding method such as the laser welding method. In this case, as illustrated in FIG. 2, a portion of the positive electrode lead 51 is sandwiched between the cover part 12 and the battery device 40, and the turning part 513 that is curved is formed on the back side relative to the location where the positive electrode lead 51 is coupled to the external terminal 20. In this manner, the outer package can 10 is formed, and the battery device 40 and other components are contained inside the outer package can 10. Assembly of the secondary battery 1 is thus completed.

The secondary battery 1 after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery 1 into an electrochemically stable state. The secondary battery 1 is thus completed.

A description is given next of a method of manufacturing the wiring unit 2 with reference to FIGS. 2A and 2B.

First, the flexible wiring substrate 21 is fabricated. Specifically, two flexible insulating films are punched into a predetermined shape to thereby obtain the first layer F1 and the second layer F2. Thereafter, the first electrically conductive member 22 is attached to a region of the second layer F2 that is to be the first insulating member 23, and the second electrically conductive member 25 is attached to a region of the second layer F2 that is to be the second insulating member 26. Further, the first wire W1 and the second wire W2 are formed by, for example, printing on a region of the second layer F2 that is to be the coupling part 28 and a region of the second layer F2 that is to be the extraction part 29. Thereafter, the first layer F1 is laid over the second layer F2 to sandwich the first electrically conductive member 22, the second electrically conductive member 25, the first wire W1, and the second wire W2 between the first layer F1 and the second layer F2. Further, the coupling terminal 29T to which the first wire W1 and the second wire W2 are to be coupled is formed at an end part of the extraction part 29.

Thereafter, the first coupling terminal 31 and the second coupling terminal 32 are prepared. Thereafter, the solder 24 is applied to the first electrically conductive member 22, and the solder 27 is applied to the second electrically conductive member 25. The first coupling terminal 31 is coupled to the first electrically conductive member 22 via the solder 24, and the second coupling terminal 32 is coupled to the second electrically conductive member 25 via the solder 27.

Thereafter, the first reinforcing member 33, the second reinforcing member 34, and the third reinforcing member 35 are each bonded to a predetermined position on a back surface of the second layer F2, that is, on a surface of the second layer F2 on an opposite side of the second layer F2 from the first layer F1.

By the above operation, the wiring unit 2 is completed.

Thereafter, the first coupling terminal 31 of the wiring unit 2 is brought into contact with the surface 20FS of the external terminal 20 of the secondary battery 1, following which the first coupling terminal 31 and the external terminal 20 are mechanically joined by a method such as the resistance welding or the laser welding. Furthermore, the second coupling terminal 32 of the wiring unit 2 is brought into contact with the lower surface 1LS of the bottom part M2 of the outer package can 10 of the secondary battery 1, following which the second coupling terminal 32 and the lower surface 1LS of the bottom part M2 are mechanically joined by a method such as the resistance welding or the laser welding.

By the above operation, the battery unit of an embodiment of the present disclosure is completed.

As described above, in the battery unit of an embodiment of the present disclosure, the secondary battery 1 is provided with the wiring unit 2. This makes it possible to electrically couple each of the external terminal 20 serving as the positive electrode terminal and the outer package can 10 serving as the negative electrode terminal in the secondary battery 1 to an external device by the flexible wiring substrate 21 of the wiring unit 2. Here, the flexible wiring substrate 21 is employed that has a configuration in which the first wire W1 and the second wire W2 are sandwiched between the first layer F1 and the second layer F2, which are the two flexible insulating films. This makes it possible to achieve a wiring layout having a relatively high degree of freedom while avoiding an electric short circuit between the positive electrode 41 and the negative electrode 42.

Furthermore, in the battery unit of an embodiment of the present disclosure, the first coupling terminal 31 of the wiring unit 2 is welded to the external terminal 20 of the secondary battery 1, and the second coupling terminal 32 of the wiring unit 2 is welded to the bottom part M2 of the outer package can 10 of the secondary battery 1. This reduces contact resistance as compared with adhesion and pressure welding, and makes it possible to avoid a decrease in the energy density extracted from the secondary battery 1. This further makes it possible to avoid coupling failure between the first coupling terminal 31 and the external terminal 20 and coupling failure between the second coupling terminal 32 and the bottom part M2 due to external factors such as impact or vibrations applied from outside the battery unit. Further, the battery unit does not include a circuit in, for example, the wiring unit 2. This makes it unnecessary to consider the influence of heat generated during welding on the circuit.

As described above, the battery unit of an embodiment of the present disclosure achieves both of high ease of handling and high reliability.

In the battery unit of an embodiment of the present disclosure, the first support part 21U has the opening 21UK that extends through the first insulating member 23 and the first electrically conductive member 22. Thus, a portion of the first coupling terminal 31 forms an exposed part exposed to the outside through the opening 21UK. This makes it possible to mechanically join the first coupling terminal 31 and the external terminal 20 to each other easily by a method such as the resistance welding or the laser welding. Similarly, the second support part 21L has the opening 21LK that extends through the second insulating member 26 and the second electrically conductive member 25. Thus, a portion of the second coupling terminal 32 forms an exposed part exposed to the outside through the opening 21LK. This makes it possible to mechanically join the second coupling terminal 32 and the bottom part M2 of the outer package can 10 to each other easily by a method such as the resistance welding or the laser welding.

In the battery unit of an embodiment of the present disclosure, the wiring unit 2 includes the first reinforcing member 33. This makes it possible to, upon attaching the wiring unit 2 to the secondary battery 1, mechanically join the first coupling terminal 31 and the external terminal 20 to each other with a surface of the first coupling terminal 31 and the surface 20FS of the external terminal 20 being favorably in contact with each other. In the battery unit of an embodiment of the present disclosure, the wiring unit 2 includes the second reinforcing member 34. This makes it possible to, upon attaching the wiring unit 2 to the secondary battery 1, mechanically join the second coupling terminal 32 and the bottom part M2 of the outer package can 10 to each other with a surface of the second coupling terminal 32 and the lower surface ILS of the bottom part M2 of the outer package can 10 being favorably in contact with each other. Furthermore, the battery unit of an embodiment of the present disclosure further includes the third reinforcing member 35. This makes it possible to easily couple the coupling terminal 29T to external wiring, or the like.

In the battery unit according to an embodiment of the present disclosure, the external terminal 20 welded to the first coupling terminal 31 is surrounded by the peripheral part 12R of the cover part 12 that is a portion of the outer package can 10 on the upper surface 1US, and a portion of the first insulating member 23 is opposed to the peripheral part 12R, which serves as the negative electrode terminal present on the outer edge of the upper surface 1US. This makes it possible to reliably avoid a short circuit between the first coupling terminal 31 and the peripheral part 12R of the cover part 12 while securing the electrical coupling between the first coupling terminal 31 and the external terminal 20.

In the battery unit of an embodiment of the present disclosure, the outer diameter of the first insulating member 23 and the outer diameter of the first reinforcing member 33 are each substantially equal to the outer diameter D of the secondary battery 1. This makes it possible to easily couple the first coupling terminal 31 and the external terminal 20 to each other.

Although the present disclosure has been described hereinabove with reference to an embodiment, the configuration of the present disclosure is not limited thereto, and is therefore modifiable in a variety of ways.

Specifically, although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed between the container part and the cover part.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

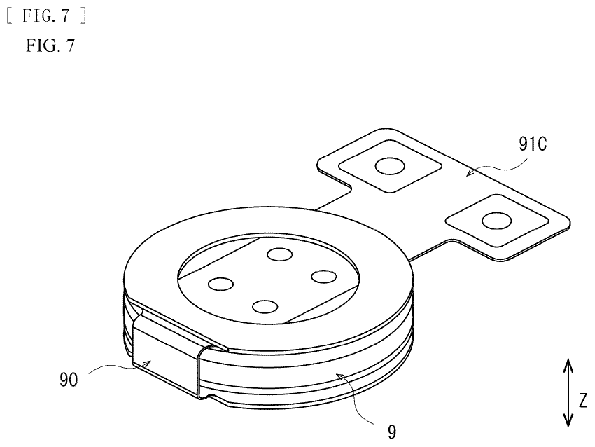

In addition, the battery unit including the secondary battery and the wiring unit for the battery have been given as examples in the above embodiment; however, the present disclosure is not limited thereto, and the battery unit may include a primary battery. FIG. 7 is a perspective diagram illustrating a configuration example of a battery unit according to a modification example of the present disclosure, and the battery unit includes a primary battery 9 instead of the secondary battery 1. In the battery unit of the above embodiment including the secondary battery 1, the flexible wiring substrate 21 has the middle part 21M, which includes the coupling part 28 and the extraction part 29. The coupling part 28 and the extraction part 29 are disposed along the side surface 1SS. The coupling part 28 and the extraction part 29 are provided with the first wire W1 and the second wire W2, which are sandwiched between the first layer F1 and the second layer F2. The first wire W1 and the second wire W2 are each coupled to the coupling terminal 29T. The coupling terminal 29T is to be coupled to an external device. However, the primary battery 9 has a height H1 lower than the height H of the secondary battery 1. Accordingly, the battery unit of FIG. 7 including the primary battery 1A employs a wiring unit 90 that includes a flexible wiring substrate 91 (to be described later). The flexible wiring substrate 91 includes an output terminal part 91C. The output terminal part 91C serves as an extraction part provided along a bottom surface 9B (to be described later) of the primary battery 9.

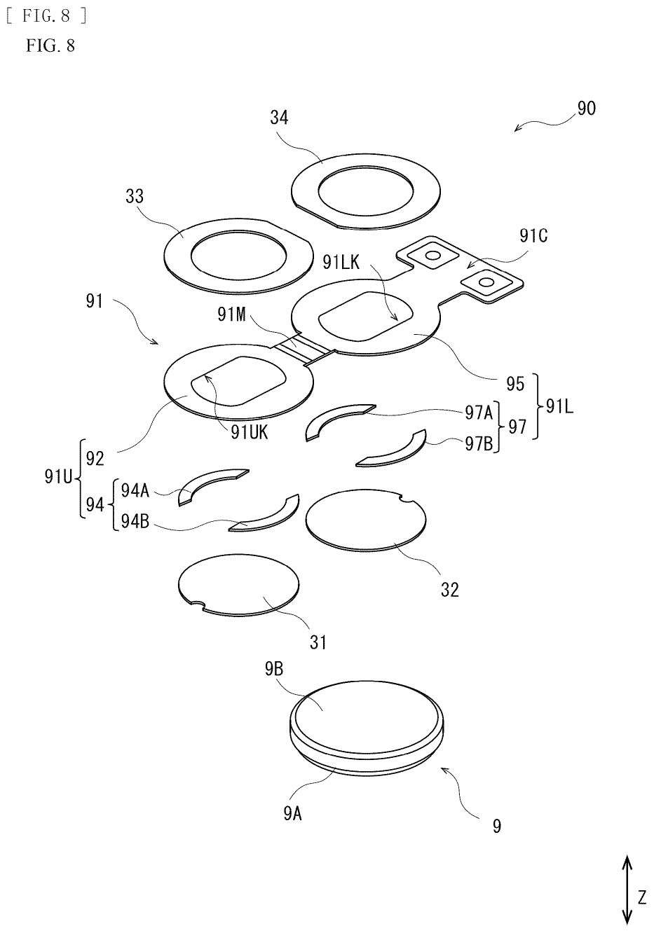

FIG. 8 is an exploded perspective diagram illustrating a configuration example of the wiring unit 90 illustrated in FIG. 7 in an unbent state. The wiring unit 90 includes, for example, the flexible wiring substrate 91 provided with the first coupling terminal 31 and the second coupling terminal 32. The first coupling terminal 31 is an electrically conductive member that is disposed to face a positive electrode terminal 9A of the primary battery 9 and is electrically joined to the positive electrode terminal 9A. The second coupling terminal 32 is an electrically conductive member that is disposed to face the bottom surface 9B of the outer package can and is electrically joined to the bottom surface 9B of the outer package can. The bottom surface 9B of the outer package can serves as the negative electrode terminal of the secondary battery 1. The flexible wiring substrate 91 includes a first support part 91U, a second support part 91L, a middle part 91M, and the output terminal part 91C.

The first support part 91U supports the first coupling terminal 31. The first support part 91U is provided to oppose the positive electrode terminal 9A exposed on a surface of the primary battery 9. The second support part 91L supports the second coupling terminal 32. The second support part 91L is provided to oppose the bottom surface 9B of the primary battery 9. The middle part 91M couples the first support part 91U and the second support part 91L to each other. The middle part 91M is provided along a side surface of the primary battery 9. Note that, although FIG. 8 illustrates the flexible wiring substrate 91 in an unbent state where all the first support part 91U, the second support part 91L, and the middle part 91M extend along the same plane, in the battery unit of an embodiment of the present disclosure, a boundary part between the first support part 91U and the middle part 91M is bent substantially vertically, and a boundary part between the second support part 91L and the middle part 91M is bent substantially vertically.

The flexible wiring substrate 91 further includes a first wire and a second wire. The first wire extends from the first coupling terminal 31, through the first support part 91U, the middle part 91M, and the second support part 91L, to the output terminal part 91C. The second wire extends from the second coupling terminal 32, through the second support part 91L, to the output terminal part 91C. The first wire and the second wire are sandwiched between, for example, two flexible insulating films.

The first support part 91U includes a first electrically conductive member 92 and solder pieces 94A and 94B. The first electrically conductive member 92 is an annular electrically conductive member that is electrically coupled to an outer edge part of the first coupling terminal 31. The first support part 91U has an opening 91UK extending through the first electrically conductive member 92. Accordingly, a portion of the first coupling terminal 31 overlaps the opening 91UK and forms an exposed part that is exposed to the outside.

The first electrically conductive member 92 and the first coupling terminal 31 may be coupled to each other by the solder pieces 94A and 94B. Note that the electrical coupling between the first electrically conductive member 22 and the first coupling terminal 31 is not necessarily achieved by solder coupling. For example, the first electrically conductive member 22 and the first coupling terminal 31 may be electrically coupled to each other by welding. The first electrically conductive member 92 includes, for example, metal such as copper.

The middle part 91M is a coupling part that couples the first support part 91U and the second support part 91L to each other.

The second support part 91L includes a second electrically conductive member 25 and solder pieces 97A and 97B. The second electrically conductive member 95 is an annular electrically conductive member that is electrically coupled to an outer edge part of the second coupling terminal 32. The second support part 91L has an opening 91LK extending through the second electrically conductive member 95. Accordingly, a portion of the second coupling terminal 32 overlaps the opening 91LK and forms an exposed part that is exposed to the outside.

The second electrically conductive member 95 and the second coupling terminal 32 may be coupled to each other by the solder pieces 97A and 97B. Note that the electrical coupling between the second electrically conductive member 95 and the second coupling terminal 32 is not necessarily achieved by solder coupling. For example, the second electrically conductive member 95 and the second coupling terminal 32 may be electrically coupled to each other by welding. The second electrically conductive member 95 includes, for example, metal such as copper.

The wiring unit 90 may further include the first reinforcing member 33 and the second reinforcing member 34. The first reinforcing member 33 is positioned on an opposite side of the first support part 91U from the first coupling terminal 31 and is fixed to the first support part 91U. The second reinforcing member 34 is positioned on an opposite side of the second support part 91L from the second coupling terminal 3 and is fixed to the second support part 91L. The first reinforcing member 33 and the second reinforcing member 34 each has an insulating property. The first reinforcing member 33 and the second reinforcing member 34 may include, for example, the insulating material having high hardness, such as a glass epoxy substrate.

In the battery unit of FIG. 7, an electromotive force of the primary battery 9 may be extracted from the output terminal part 91C.

The effects described herein are mere examples, and effects of the present technology are therefore not limited to those described herein. Accordingly, the present technology may achieve any other effect.

The present disclosure may encompass the following embodiments.

<1>

A battery unit including:
a battery including a first surface on which a first electrode terminal is exposed, a second surface on which a second electrode terminal is exposed, and a side surface coupling the first surface and the second surface to each other, the second surface being disposed on a side opposite to the first surface; and
a wiring unit including a first coupling terminal to be welded to the first electrode terminal, a second coupling terminal to be welded to the second electrode terminal, and a flexible wiring substrate, in which
the flexible wiring substrate includes
   a first support part supporting the first coupling terminal,
   a second support part supporting the second coupling terminal,
   a middle part coupling the first support part and the second support part to each other,
   a first wire extending from the first coupling terminal, through the first support part, to the middle part, and
   a second wire extending from the second coupling terminal, through the second support part, to the middle part.
      <2>

The battery unit according to <1>, in which
the second electrode terminal extends from the second surface of the battery, through the side surface, to an outer edge of the first surface, and
the first electrode terminal is surrounded by a portion of the second electrode terminal on the first surface.
   <3>

The battery unit according to <2>, in which
the first support part includes a first electrically conductive member and a first insulating member, the first electrically conductive member being annular and coupled to an outer edge part of the first coupling terminal, the first insulating member supporting the first electrically conductive member, and
the first insulating member is opposed to the second electrode terminal that is present on the outer edge of the first surface.
   <4>

The battery unit according to <3>, in which
the first support part has an opening that extends through the first insulating member and the first electrically conductive member, and
the first coupling terminal includes an exposed part that overlaps the opening.
   <5>

The battery unit according to any one of <1> to <4>, in which the wiring unit further includes
a first reinforcing member positioned on an opposite side of the first support part from the first surface and is fixed to the first support part, and
a second reinforcing member positioned on an opposite side of the second support part from the second surface and is fixed to the second support part.
   <6>

The battery unit according to <5>, in which the first reinforcing member and the second reinforcing member each have an insulating property.

<7>

The battery unit according to any one of <1> to <6>, in which the middle part is provided along the side surface of the battery.

<8>

The battery unit according to any one of <1> to <7>, in which the first support part has an outer diameter that is substantially equal to an outer diameter of the battery.

<9>

A wiring unit for a battery, the wiring unit being mountable on the battery including a positive electrode terminal and a negative electrode terminal, the wiring unit including:
a first coupling terminal to be welded to the positive electrode terminal;
a second coupling terminal to be welded to the negative electrode terminal; and
a flexible wiring substrate, in which
the flexible wiring substrate includes
   a first support part supporting the first coupling terminal,
   a second support part supporting the second coupling terminal,
   a middle part coupling the first support part and the second support part to each other,
   a first wire extending from the first coupling terminal, through the first support part, to the middle part, and
   a second wire extending from the second coupling terminal, through the second support part, to the middle part.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery unit comprising:
a battery including a first surface on which a first electrode terminal is exposed, a second surface on which a second electrode terminal is exposed, and a side surface coupling the first surface and the second surface to each other, the second surface being disposed on a side opposite to the first surface; and
a wiring unit including a first coupling terminal to be welded to the first electrode terminal, a second coupling terminal to be welded to the second electrode terminal, and a flexible wiring substrate, wherein
the flexible wiring substrate includes
a first support part supporting the first coupling terminal,
a second support part supporting the second coupling terminal,
a middle part coupling the first support part and the second support part to each other,
a first wire extending from the first coupling terminal, through the first support part, to the middle part, and
a second wire extending from the second coupling terminal, through the second support part, to the middle part.

2. The battery unit according to claim 1, wherein
the second electrode terminal extends from the second surface of the battery, through the side surface, to an outer edge of the first surface, and
the first electrode terminal is surrounded by a portion of the second electrode terminal on the first surface.

3. The battery unit according to claim 2, wherein
the first support part includes a first electrically conductive member and a first insulating member, the first electrically conductive member being annular and coupled to an outer edge part of the first coupling terminal, the first insulating member supporting the first electrically conductive member, and
the first insulating member is opposed to the second electrode terminal that is present on the outer edge of the first surface.

4. The battery unit according to claim 3, wherein
the first support part has an opening that extends through the first insulating member and the first electrically conductive member, and
the first coupling terminal includes an exposed part that overlaps the opening.

5. The battery unit according to claim 1, wherein the wiring unit further includes
a first reinforcing member positioned on an opposite side of the first support part from the first surface and is fixed to the first support part, and
a second reinforcing member positioned on an opposite side of the second support part from the second surface and is fixed to the second support part.

6. The battery unit according to claim 5, wherein the first reinforcing member and the second reinforcing member each have an insulating property.

7. The battery unit according to claim 1, wherein the middle part is provided along the side surface of the battery.

8. The battery unit according to claim 1, wherein the first support part has an outer diameter that is substantially equal to an outer diameter of the battery.

9. A wiring unit for a battery, the wiring unit being mountable on the battery including a positive electrode terminal and a negative electrode terminal, the wiring unit comprising:
a first coupling terminal to be welded to the positive electrode terminal;
a second coupling terminal to be welded to the negative electrode terminal; and
a flexible wiring substrate, wherein
the flexible wiring substrate includes
a first support part supporting the first coupling terminal,
a second support part supporting the second coupling terminal,
a middle part coupling the first support part and the second support part to each other,
a first wire extending from the first coupling terminal, through the first support part, to the middle part, and
a second wire extending from the second coupling terminal, through the second support part, to the middle part.
